(19) United States
(12) Patent Application Publication
(10) Pub. No.: US 2007/0094478 A1
(43) Pub. Date: Apr. 26, 2007

(54) Pointer computation method and system for a scalable, programmable circular buffer

(76) Inventors: Erich Plondke, Austin, TX (US); Lucian Codrescu, Austin, TX (US); Muhammad Ahmed, Austin, TX (US); Mao Zeng, Austin, TX (US); Sujat Jamil, Austin, TX (US); William C. Anderson, Austin, TX (US)

Correspondence Address: QUALCOMM INCORPORATED, 5775 MOREHOUSE DR., SAN DIEGO, CA, 92121, US

(21) Appl. No.: 11/255,434

(22) Filed: Oct. 20, 2005

(51) Int. Cl. G06F 12/00

(52) U.S. Cl. 711/219; 711/110

(57) ABSTRACT

Techniques for processing digital signals for a variety of applications, including in a communications (e.g., CDMA) system. A pointer location within a circular buffer is determined by establishing a length of the circular buffer, a start address that is aligned to a power of 2, and an end address located distant from the start address by the length and less than a power of 2 greater than the length. The method and system determine a current pointer location for an address within the circular buffer, a stride value of bits between the start address and the end address, a new pointer location within the circular buffer that is shifted from the current pointer location by the number of bits of the stride value. An adjusted pointer location is within the circular buffer by an arithmetic operation of the new pointer location with the length.

### FIELD

The disclosed subject matter relates to data processing. More particularly, this disclosure relates to a novel and improved pointer computation method and system for a scalable, programmable circular buffer.

### DESCRIPTION OF THE RELATED ART

Increasingly, electronic equipment and supporting software applications involve signal processing. Home theater, computer graphics, medical imaging and telecommunications all rely on signal-processing technology. Signal processing requires fast math in complex, but repetitive algorithms. Many applications require computations in real-time, i.e., the signal is a continuous function of time, which must be sampled and converted to digital, for numerical processing. The processor must thus execute algorithms performing discrete computations on the samples as they arrive. The architecture of a digital signal processor (DSP) is optimized to handle such algorithms. The characteristics of a good signal processing engine typically may include fast, flexible arithmetic computation units, unconstrained data flow to and from the computation units, extended precision and dynamic range in the computation units, dual address generators, efficient program sequencing, and ease of programming.

One promising application of DSP technology includes communications systems such as a code division multiple access (CDMA) system that supports voice and data communication between users over a satellite or terrestrial link. The use of CDMA techniques in a multiple access communication system is disclosed in U.S. Pat. No. 4,901,307, entitled “SPREAD SPECTRUM MULTIPLE ACCESS COMMUNICATION SYSTEM USING SATELLITE OR TERRESTRIAL REPEATERS,” and U.S. Pat. No. 5,103,459, entitled “SYSTEM AND METHOD FOR GENERATING WAVEFORMS IN A CDMA CELLULAR TELEHANDSET SYSTEM,” both assigned to the assignee of the claimed subject matter.

A CDMA system is typically designed to conform to one or more telecommunications, and now streaming video , standards. One such first generation standard is the “TIA/EIA/IS-95 Terminal-Base Station Compatibility Standard for Dual-Mode Wideband Spread Spectrum Cellular System,” hereinafter referred to as the IS-95 standard. The IS-95 CDMA systems are able to transmit voice data and packet data. A newer generation standard that can more efficiently transmit packet data is offered by a consortium named “3^{rd} Generation Partnership Project” (3GPP) and embodied in a set of documents including Document Nos. 3G TS 25.211, 3G TS 25.212, 3G TS 25.213, and 3G TS 25.214, which are readily available to the public. The 3 GPP standard is hereinafter referred to as the W-CDMA standard. There are also video compression standards, such as MPEG-1, MPEG-2, MPEG-4, H.263, and WMV (Windows Media Video), as well as many others that such wireless handsets will increasingly employ.

In many applications, buffers are widely used. A common type is a circular buffer that wraps around itself, so that the lowest numbered entry is conceptually or logically located adjacent to its highest numbered entry although physically they are apart by the buffer length or range. The circular buffer provides direct access to the buffer, so as to allow a calling program to construct output data in place, or parse input data in place, without the extra step of copying data to or from a calling program. In order to facilitate this direct access, the circular buffer makes sure that all references to buffer locations for either output or input are to a single contiguous block of memory. This avoids the problem of the calling program not having to deal with split buffer spaces when the cycling of data reaches the circular buffer end location. As a result, the calling program may use a wide variety of applications available without the need to be aware that the applications are operating directly in a circular buffer.

One type of circular buffer requires the buffer to be both power-of-2 aligned as well as have a length that is a power of 2. In such a circular buffer, the point calculation simply involves a masking step. While this may provide a simple calculation, the requirement of the buffer length being a power of 2 makes such a circular buffer not useable by certain algorithms or implementations.

In the use of a circular buffer, the length of the buffer includes a starting location and an ending location. For many applications, it would be desirable for the starting location and ending location to be determinable or programmable. With a programmable starting location and ending location for the circular buffer, a wider variety of algorithms and processes could use the circular buffer. Moreover, as the different algorithms and processes change, the circular buffer's operation could also change so as to provide increased operational efficiency and utility.

In addressing a particular location in the circular buffer, a pointer that addresses a particular buffer location will move either up or down to the buffer location. This process, unfortunately, is less than fully efficient. Oftentimes, the process is cumbersome in that it requires three addition/subtraction operations. A first operation is required to generate a new buffer pointer by adding a stride to the current buffer pointer. A second operation is required to determine if the new pointer has overflowed or underflowed the buffer address range. Then, a third operation is required to adjust the new pointer in case of an overflow or an underflow. These 3 operations require either 3 separate adders in a perfectly pipelined operation or alternately require the circular addressing to become a non-pipelineable multi-cycle operation. If it were possible to reduce the number of these operations, then significant DSP improvements could result from either the area and/or power savings of fewer adders or performance improvement since these operations occur numerous times during DSP and other applications.

A need exists, therefore, for a pointer computation method useable in a class of scalable and programmable circular buffers, which class of circular buffers supports a programmable buffer length.

Furthermore, a need exists for a pointer computation method for a class of scalable and programmable circular buffers that requires as few additions as possible to detect the wrap around conditions, and that permits adjustment of the pointer value in the event that the temporary pointer exceeds the circular buffer boundary.

### SUMMARY

Techniques for making and using a pointer computation method and system for a scalable, programmable circular buffer are disclosed, which techniques improve both the operation of a digital signal processor and the efficient use of digital signal processor instructions for processing increasingly robust software applications for personal computers, personal digital assistants, wireless handsets, and similar electronic devices, as well as increasing the associated digital processor speed and service quality.

According to one aspect of the disclosed subject matter, there is provided a method and a system for determining a circular buffer pointer location. A pointer location within a circular buffer is determined by establishing a length of the circular buffer, a start address that is aligned to a power of 2, and an end address located distant from the start address by the length and less than a power of 2 greater than the length. The method and system determine a current pointer location for an address within the circular buffer, a stride value of bits between the start address and the end address, a new pointer location within the circular buffer that is shifted from the current pointer location by the number of bits of the stride value. An adjusted pointer location is within the circular buffer by an arithmetic operation of the new pointer location with the length. In the event of a positive stride, the adjusted pointer location is determined by, in the event that the new pointer location is less than the end address, adjusting the adjusted pointer location to be the new point location. Alternatively, in the event that the new pointer location is greater than the end address, adjusting the adjusted pointer by subtracting the length from the new pointer location. The adjusted pointer location is set, in the event of a negative stride by, in the event that the new pointer location is greater than said start address, adjusting the adjusted pointer location to be the new point location. Alternatively, in the event that the new pointer location is less than said start address, adjusting the adjusted pointer by adding the length to the new pointer location.

These and other aspects of the disclosed subject matter, as well as additional novel features, will be apparent from the description provided herein. The intent of this summary is not to be a comprehensive description of the claimed subject matter, but rather to provide a short overview of some of the subject matter's functionality. Other systems, methods, features and advantages here provided will become apparent to one with skill in the art upon examination of the following FIGURES and detailed description. It is intended that all such additional systems, methods, features and advantages that are included within this description, be within the scope of the accompanying claims.

### BRIEF DESCRIPTIONS OF THE DRAWINGS

The features, nature, and advantages of the disclosed subject matter will become more apparent from the detailed description set forth below when taken in conjunction with the drawings in which like reference characters identify correspondingly throughout and wherein:

FIG. 1 is a simplified block diagram of a communications system for implementing the present embodiment;

FIG. 2 illustrates a DSP architecture for carrying forth the teachings of the present embodiment;

FIG. 3 presents a top level diagram of a control unit, data unit, and other digital signal processor functional units in a pipeline employing the disclosed embodiment;

FIG. 4 presents a representative data unit block partitioning for the disclosed subject matter, including an address generating unit for employing the claimed subject matter;

FIG. 5 shows conceptually the operation of a circular buffer for use with the teachings of the disclosed subject matter;

FIG. 6 provides a table representative of addressing modes, offset selects, and effective address select options for one implementation of the disclosed subject matter;

FIG. 7 portrays a block diagram of a pointer computation method and system for a scalable, programmable circular buffer according to the disclosed subject matter; and

FIG. 8 provides an embodiment of the disclosed subject matter as may operate within the execution pipeline of an associated DSP.

### DETAILED DESCRIPTION OF THE SPECIFIC EMBODIMENTS

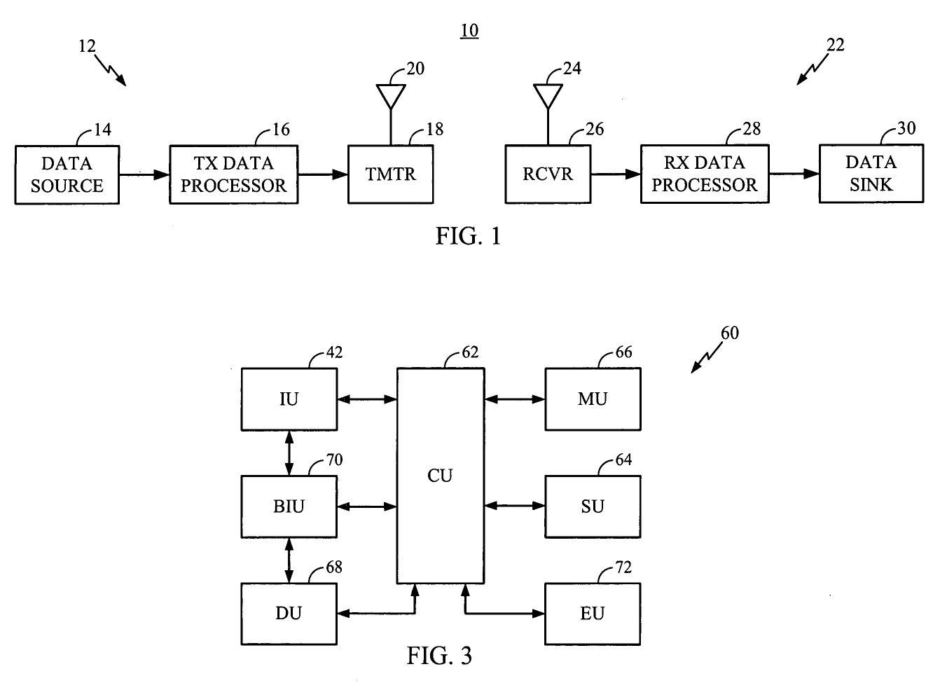

The disclosed subject matter for a novel and improved pointer computation method and system for a scalable, programmable circular buffer for a multithread digital signal processor has application in a very wide variety of digital signal processing applications involving multi-thread processing. One such application appears in telecommunications and, in particular, in wireless handsets that employ one or more digital signal processing circuits. FIG. 1, therefore, provides is a simplified block diagram of a communications system 10 that can implement the presented embodiments. At a transmitter unit 12, data is sent, typically in sets, from a data source 14 to a transmit (TX) data processor 16 that formats, codes, and processes the data to generate one or more analog signals. The analog signals are then provided to a transmitter (TMTR) 18 that modulates, filters, amplifies, and up converts the baseband signals to generate a modulated signal. The modulated signal is then transmitted via an antenna 20 to one or more receiver units.

At a receiver unit 22, the transmitted signal is received by an antenna 24 and provided to a receiver (RCVR) 26. Within receiver 26, the received signal is amplified, filtered, down converted, demodulated, and digitized to generate in phase (I) and (Q) samples. The samples are then decoded and processed by a receive (RX) data processor 28 to recover the transmitted data. The decoding and processing at receiver unit 22 are performed in a manner complementary to the coding and processing performed at transmitter unit 12. The recovered data is then provided to a data sink 30.

The signal processing described above supports transmissions of voice, video, packet data, messaging, and other types of communication in one direction. A bi-directional communications system supports two-way data transmission. However, the signal processing for the other direction is not shown in FIG. 1 for simplicity. Communications system 10 can be a code division multiple access (CDMA) system, a time division multiple access (TDMA) communications system (e.g., a GSM system), a frequency division multiple access (FDMA) communications system, or other multiple access communications system that supports voice and data communication between users over a terrestrial link. In a specific embodiment, communications system 10 is a CDMA system that conforms to the W-CDMA standard.

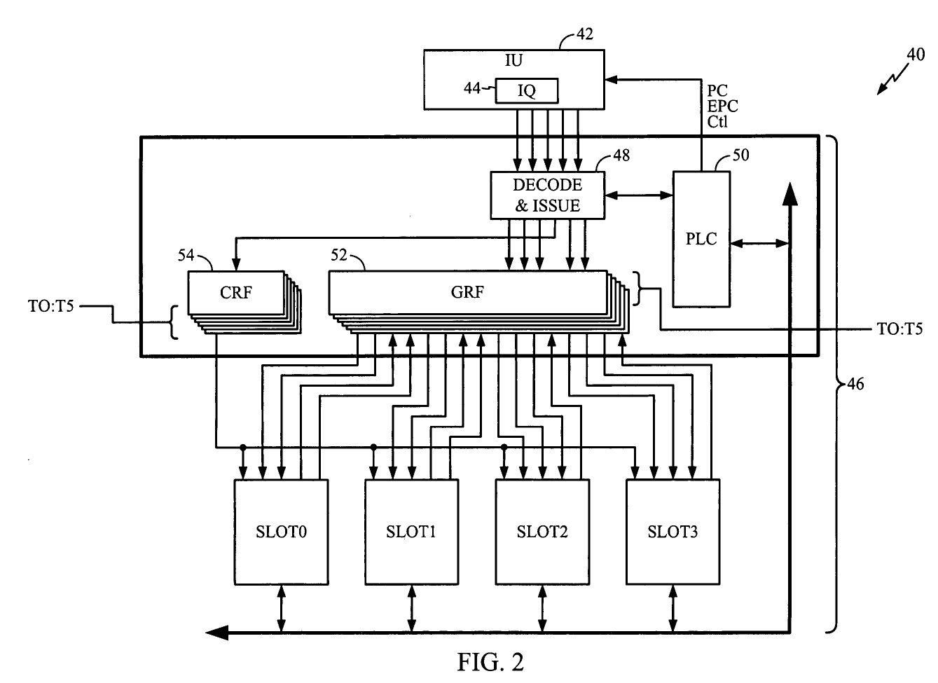

FIG. 2 illustrates DSP 40 architecture that may serve as the transmit data processor 16 and receive data processor 28 of FIG. 1. Recognize that DSP 40 only represents one embodiment among a great many of possible digital signal processor embodiments that may effectively use the teachings and concepts here presented. In DSP 40, therefore, threads T0 through T5 (“T0:T5”), contain sets of instructions from different threads. Instruction unit (IU) 42 fetches instructions for threads T0:T5. IU 42 queues instructions I0 through I3 (“I0:I3”) into instruction queue (IQ) 44. IQ 44 issues instructions I0:I3 into processor pipeline 46. Processor pipeline 46 includes control circuitry as well as a data path. From IQ 44, a single thread, e.g., thread T0, may be selected by decode and issue circuit 48. Pipeline logic control unit (PLC) 50 provides logic control to decode and issue circuitry 48 and IU 42.

IQ 44 in IU 42 keeps a sliding buffer of the instruction stream. Each of the six threads T0:T5 that DSP 40 supports has a separate eight-entry IQ 44, where each entry may store one VLIW packet or up to four individual instructions. Decode and issue circuitry 48 logic is shared by all threads for decoding and issuing a VLIW packet or up to two superscalar instructions at a time, as well as for generating control buses and operands for each pipeline SLOT0:SLOT3. In addition, decode and issue circuitry 48 does slot assignment and dependency check between the two oldest valid instructions in IQ 44 entry for instruction issue using, for example, using superscalar issuing techniques. PLC 50 logic is shared by all threads for resolving exceptions and detecting pipeline stall conditions such as thread enable/disable, replay conditions, maintains program flow etc.

In operation, general register file (GRF) 52 and control register file (CRF) 54 of selected thread is read, and read data is sent to execution data paths for SLOT0:SLOT3. SLOT0:SLOT3, in this example, provide for the packet grouping combination employed in the present embodiment. Output from SLOT0:SLOT3 returns the results from the operations of DSP 40.

The present embodiment, therefore, may employ a hybrid of a heterogeneous element processor (HEP) system using a single microprocessor with up to six threads, T0:T5. Processor pipeline 46 has six pipeline stages, matching the minimum number of processor cycles necessary to fetch a data item from IU 42. DSP 40 concurrently executes instructions of different threads T0:T5 within a processor pipeline 46. That is, DSP 40 provides six independent program counters, an internal tagging mechanism to distinguish instructions of threads T0:T5 within processor pipeline 46, and a mechanism that triggers a thread switch. Thread-switch overhead varies from zero to only a few cycles.

FIG. 3 provides a brief overview of the DSP 40 micro-architecture for one manifestation of the disclosed subject matter. Implementations of the DSP 40 micro-architecture support interleaved multithreading (IMT). The subject matter here disclosed deals with the execution model of a single thread. The software model of IMT can be thought of as a shared memory multiprocessor. A single thread sees a complete uni-processor DSP 40 with all registers and instructions available. Through coherent shared memory facilities, this thread is able to communicate and synchronize with other threads. Whether these other threads are running on the same processor or another processor is largely transparent to user-level software.

Turning to FIG. 3, the present micro-architecture 60 for DSP 40 includes control unit (CU) 62, which performs many of the control functions for processor pipeline 46. CU 62 schedules threads and requests mixed 16-bit and 32-bit instructions from IU 42. CU 62, furthermore, schedules and issues instructions to three execution units, shift-type unit(SU) 64, multiply-type unit (MU) 66, and load/store unit (DU) 68. CU 62 also performs superscalar dependency checks. Bus interface unit (BIU) 70 interfaces IU 42 and DU 68 to a system bus (not shown).

SLOT0 and SLOT1 pipelines are in DU 68, SLOT2 is in MU 66, and SLOT3 is in SU 64. CU 62 provides source operands and control buses to pipelines SLOT0:SLOT3 and handles GRF 52 and CRF 54 file updates. GRF 52 holds thirty-two 32-bit registers which can be accessed as single registers, or as aligned 64-bit pairs. Micro-architecture 60 features a hybrid execution model that mixes the advantages of superscalar and VLIW execution. Superscalar issue has the advantage that no software information is needed to find independent instructions. A decode stage, DE, performs the initial decode of instructions so as to prepare such instructions for execution and further processing in DSP 40. A register file pipeline stage, RF, provides for registry file updating. Two execution pipeline stages, EX1 and EX2, support instruction execution, while a third execution pipeline stage, EX3, provides both instruction execution and register file update. During the execution, (EX1, EX2, and EX3) and writeback (WB) pipeline stages IU 42 builds the next IQ 44 entry to be executed. Finally, writeback pipeline stage, WB, performs register update. The staggered write to register file operation is possible due to IMT micro-architecture and saves the number of write ports per thread. Because the pipelines have six stages, CU 52 may issue up to six different threads.

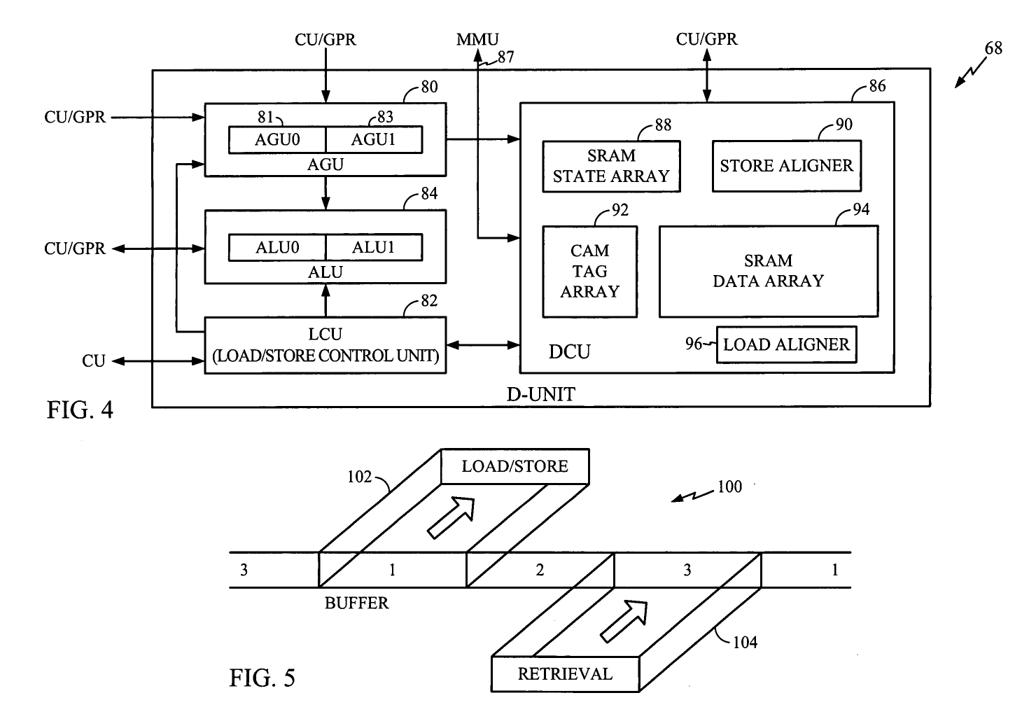

FIG. 4 presents a representative data unit, DU 68, block partitioning wherein may apply the disclosed subject matter. DU 68 includes an address generating unit, AGU 80, which further includes AGU0 81 and AGU1 83 for receiving input from CU 62. The subject matter here disclosed has principal application with the operation of AGU 80. Load/store control unit, LCU 82, also communicates with CU 62 and provides control signals to AGU 80 and ALU 84, as well as communicates with data cache unit, DCU 86. ALU 84 also receives input from AGU 80 and CU 62. Output from AGU 80 goes to DCU 86. DCU 86 communicates with memory management unit (“MMU”) 87 and CU 62. DCU 86 includes SRAM state array circuit 88, store aligner circuit 90, CAM tag array 92, SRAM data array 94, and load aligner circuit 96.

To further explain the operation of DU 68, wherein the claimed subject matter may operate, reference is now made to the basic functions performed therein according to the several partitions of the following description. In particular, DU 68 executes load-type, store-type, and 32-bit instructions from ALU 84. The major features of DU 68 include fully pipelined operation in all of DSP 40 pipeline stages, DE, RF, EX1, EX2, EX3, and WB pipeline stages using the two parallel pipelines of SLOT0 and SLOT1. DU 68 may accept either VLIW or superscalar dual instruction issue. Preferably, SLOT0 executes uncacheable or cacheable load or store instructions, 32-bit ALU 84 instructions, and DCU 86 instructions. SLOT1 executes uncacheable or cacheable load instructions and 32-bit ALU 84 instructions.

DU 68 receives up to two decoded instructions per cycle from CU 60 in the DE pipeline stage including immediate operands. In the RF pipeline stage, DU 68 receives general purpose register (GPR) and/or control register (CR) source operands from the appropriate thread specific registers. The GPR operand is received from the GPR register file in CU 60. In the EX1 pipeline stage, DU 68 generates the effective address (EA) of a load or store memory instruction. The EA is presented to MMU 87, which performs the virtual to physical address translation and page level permissions checking and provides page level attributes. For accesses to cacheable locations, DU 68 looks up the data cache tag in the EX2 pipeline stage with the physical address. If the access hits, DU 68 performs the data array access in the EX3 pipeline stage.

For cacheable loads, the data read out of the cache is aligned by the appropriate access size, zero/sign extended as specified and driven to CU 60 in the WB pipeline stage to be written into the instruction specified GPR. For cacheable stores, the data to be stored is read out of the thread specific register in the CU 60 in the EXI pipeline stage and written into the data cache array on a hit in the EX2 pipeline stage. For both loads and stores, auto-incremented addresses are generated in the EX1 and EX2 pipeline stages and driven to CU 60 in the EX3 pipeline stage to be written into the instruction specified GPR.

DU 68 also executes cache instructions for managing DCU 86. The instructions allow specific cache lines to be locked and unlocked, invalidated, and allocated to a GPR specified cache line. There is also an instruction to globally invalidate the cache. These instructions are pipelined similar to the load and store instructions. For loads and stores to cacheable locations that miss the data cache, and for uncacheable accesses, DU 68 presents requests to BIU 70. Uncacheable loads present a read request. Store hits, misses and uncacheable stores present a write request. DU 68 tracks outstanding read and line fill requests to BIU 70. DU 68 provides a non-blocking inter-thread, i.e., allows accesses by other threads while one or more threads are blocked pending completion of outstanding load requests.

AGU 80, to which the present disclosure pertains, provides two identical instances of the AGU 80 data path, one for SLOT0 and one for SLOT1. Note, however, that the disclosed subjected matter may operate, and actually does exist and operate, in other blocks of DU 68, such as ALU 84. For illustrative purposes in understanding the function and structure of the disclosed subject matter, attention is directed, however, to AGU 80 which generates both the effective address (EA) and the auto-incremented address (AIA) for each slot according to the exemplary teachings herein provided.

LCU 82 enables load and store instruction executions, which may include cache hits, cache misses, and uncacheable loads, as well as store instructions. In the present embodiment, the load pipeline is identical for SLOT0 and SLOT1. The store execution via LCU 82 provides a store instruction pipeline write through cache hit instructions, write back cache hit instruction, cache miss instructions, uncacheable write instructions. Store instructions only execute on SLOT0 with the present embodiment. On a write-through store, a write request is presented to BIU 70, regardless of hit condition. On a write-back store, a write request is presented to BIU 70 if there is a miss, and not if there is a hit. On a write-back store hit, the cache line state is updated. A store miss presents a write request to BIU 70 and does not allocate a line in the cache.

ALU 84 includes ALUO 85 and ALUL 89, one for each slot. ALU 84 contains the data path to perform arithmetic/transfer/compare (ATC) operations within DU 68. These may include 32-bit add, subtract, negate, compare, register transfer, and MUX register instructions. In addition, ALU 84 also completes the circular addressing for the AIA computation.

FIG. 5 shows conceptually the operation of a circular buffer for use with the teachings of the disclosed subject matter. When multiple execution threads are scheduled to run in parallel on DSP 40, they may interact in a way that increases jitter in their individual loop execution times. Techniques for implementing deterministic data streaming when AGU 80 must transfer large amounts of data to LCU 82. In order to avoid data loss, LCU 82 must be able to keep up with the acquisition component by retrieving the data as soon as it is ready.

Referring to FIG. 5, circular buffer 100 that allocates buffer memory into a number of sections. In operation, AGU 80 fills a section, e.g., section 102, of circular buffer 100 while LCU 82 reads the data as soon as possible from another section, e.g., section 104. Circular buffer 100 allows both LCU 82 and AGU 80 to access data in the buffer simultaneously, because at any time they read and write data in different buffer sections. Circular buffer 100, therefore, continues writing at the beginning of section 102 while reading from section 104, for example. One responsibility of AGU 80 includes keeping up with AGU 80 so that data is never overwritten. A synchronization mechanism allows AGU 80 to inform LCU 82 when new data is available.

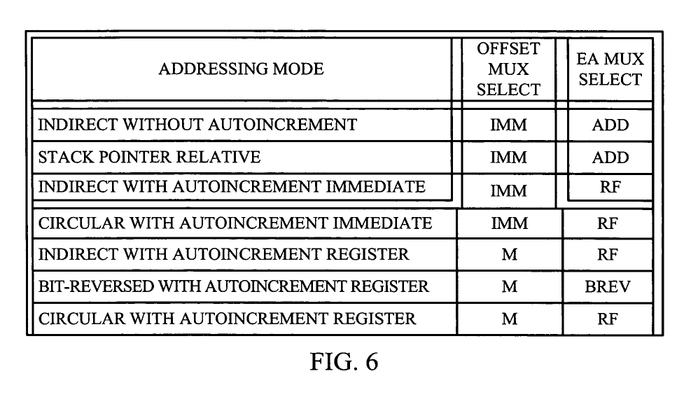

FIG. 6 provides a table 106 representative of addressing modes, offset selects, and effective address select options for one implementation of the disclosed subject matter. The table of FIG. 6, therefore, lists the major instruction decodes for instructions executed by DU 68. Much of the decode functionality resides in CU 60 and decoded signals are driven to DU 68 as part of the decoded instruction delivery. Thus, the indirect without autoincrement and stack pointer relative addressing modes use the Imm offset MUX select and Add EA MUX select. The indirect and circular with autoincrement immediate addressing modes use the Imm offset MUX select and RF EA MUX select. The indirect with autoincrement register and circular with autoincrement register addressing modes use the M offset MUX select and RF EA MUX select. Finally, the bit-reversed with autoincrement register addressing mode employs the M offset MUX select and BRev, or bit reversed, EA MUX select. Upon performing the various decode functions here described, the present method and system may perform the following pointer location calculation operations as here described.

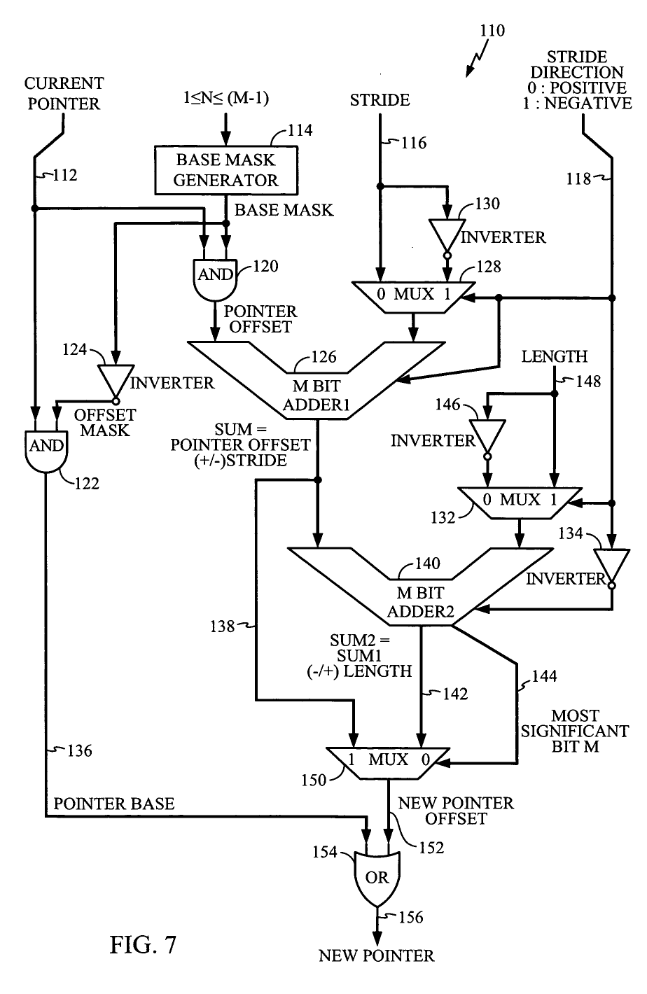

FIG. 7 features an embodiment of the present disclosure, which first involves establishing definitions for an algorithmic process. Within such definitions, let M represent an integer and refer to an M Bit Adder; let N be an integer greater than 0 and less than M, i.e., 0<N<M. Assume that N is scalable and programmable within 0<N<M. Furthermore, set M as a reference to M-Bit Adder. Circular buffer 100 may be formed as a 2^{N} aligned base pointer and have a programmable length, L, where L<2N.

With these definitions, reference is now made to FIG. 7, which presents an illustrative schematic block diagram 110 for performing the present pointer computation method and system for a scalable, programmable circular buffer. Block diagram 110 includes as inputs current pointer, R, at 112, base mask generator input, at 114, stride input, at 116, and stride direction (either 0 for the positive direction, or 1 for the negative direction) at 118. Current pointer input R goes to AND gates 120 and 122. Base mask generator input 114 goes to AND gate 122 and inverter 124, which provides an offset mask to AND gate 120. Based on value of N, base mask generator 114 generates the mask for bits N−1:0. That is, bits B_{M-1}:B_{N} may all be set to zero, while bits B_{N-1}:B_{O} may all be set to 1. Output from AND gate 122 provides a pointer offset to M-bit adder 126.

Stride input 116 goes to MUX 128 and inverter 130, which provides an inverted input to MUX 128. Stride direction input 118 also goes to MUX 128, M-bit adder 126, MUX 132 and inverter 134. AND gate 122 derives a pointer offset as the bitwise AND of current pointer input 112 and the base mask from base mask generator 114. AND gate 120 derives a pointer base 136 from the logical AND of current pointer 112 and the offset mask from inverter 124, which offset mask is the inverted output from base mask generator 114.

M-bit adder 126 generates a summand 138 for M-bit adder 140. The summand derives from the summation of a pointer offset from AND gate 122, multiplexed output from MUX 128, and stride direction 118 input. M-bit adder 140 derives a summation 142 from summand 138, multiplexed output from MUX 132, and inverter 134. Summation 142 equals summand 138 plus/minus the circular buffer length 144. Circular buffer length 144 derives from MUX 132 in response to inputs from inverter 146 and length input 148. Summation 142, summand 138, and the most significant bit M 183 from M-bit adder 140 feed to MUX 150 to yield the new pointer offset 152. Finally, OR gate 154 performs a logical OR operation using the multiplexed output from MUX 150 and pointer base 136 to yield the desired new pointer 156.

Clear advantages of the disclosed process over known methods include the requirement of only two additions, i.e., the operations of M-bit adders 126 and 140. Also, the disclosed process and system permit varying N and M to derive a family of circular buffers. As such the disclosed embodiment provides for design optimizations across power, speed, and area design considerations. Furthermore, the present process and system support a signed offset and programmable circular buffer lengths. Still another advantage of the present embodiment includes requiring only generic M-bit adders with no required intermediate bit carry terms. In addition, the disclosed embodiment may use the same data path for both positive and negative strides.

To illustrate the beneficial effects of the present method, the following examples are provides. So, let N equal 5, L equal 30 (i.e., B011110), where M equals N+1=6. The current pointer, P, current stride, S, and sign of stride, D, all of which are variables in the following example. The result of the disclosed process examples provides the various new pointer locations within circular buffer 100.

In the first example, let P=62(B111110), S=1(B000001), and D=Positive (B0) (which is an overflow case). In such case, the mask from base mask generator 114 is 011111, the pointer offset from AND gate 122 is 011110, and the pointer base 136 from AND gate 120 is 100000. Summand 138 from M-bit adder 126 is 011110 +000001=011111. Summation 142 becomes 011111+100001+000001 =000001. The new pointer offset is determined based on Bit6 being 0 for summation 142. This results in the selection of summation 142, which is 000001, as the new pointer offset. The new pointer then becomes 000001+100000=100001

In a second example, let P=62(B111110),S=1(B000001), and D=Negative(B1). In such case, the mask from base mask generator 114 is 011111, the pointer offset from AND gate 122 is 011110, and the pointer base 136 from AND gate 120 is 100000. Summand 138 from M-bit adder 126 is 011110+111110+000001=011101. Summation 142 becomes 011101+011110=111011. The new pointer offset is determined based on Bit6 being 1 for summation 142 for summation 142. This results in the selection of summand 138, which is 011101 as the new pointer offset. The new pointer then becomes 011101+100000=111101.

In a third example, let P=33(B100001),S=1(B000001), and D=Positive(B0). In such case, the mask from base mask generator 114 is 011111, the pointer offset from AND gate 122 is 000001, and the pointer base 136 from AND gate 120 is 100000. Summand 138 from M-bit adder 126 is 000001+000001+000010=011101. Summation 142 becomes 000010+100001=100100. The new pointer offset is determined based on Bit6 being 1 for summand 138. This results in the selection of summand 138, which is 000010 as the new pointer offset. The new pointer, then becomes 000010+100000=100010.

In a fourth example, let P=33(B100001), S=1(B000001), and D=Negative(B1), which is an underflow case. In such case, the mask from base mask generator 114 is 011111, the pointer offset from AND gate 122 is 000001, and the pointer base 136 from AND gate 120 is 100000. Summand 138 from M-bit adder 126 is 000001 +111110+000001=0111101. Summation 142 becomes 000000+011110=011110. The new pointer offset is determined based on Bit6 being 1 for summation 142. This results in the selection of summation 142, which is 011110 as the new pointer offset. The new pointer, then becomes 011101+100000=111110.

The disclosed subject matter, therefore, provides a pointer computation method and system for a scalable, programmable circular buffer 100 wherein the starting location of circular buffer 100 aligns to a power of two corresponding to the size of circular buffer 100. A separate register contains the length of circular buffer 100. By aligning the base of circular buffer 100, the disclosed subject matter requires only subtraction operation to achieve a pointer location. With such a process, only two additions, using two M-Bit adders, as herein described are needed. The present approach permits varying N and M to derive an optimal family of circular buffers 100 across a number of different power, speed and area metrics. The present method and system support signed offset and programmable lengths. In addition, the disclosed subject matter requires only generic M-Bit adders with no intermediate bit carry terms, while using the same data-path for both positive and negative strides.

The present method and system with a starting location, S, which is aligned to a power of two corresponding to a memory size that can contain a buffer length, L. The buffer length, L, may or may not need be stored as state in DU 68. The process takes a number of bits, B, which is the power of two greater than L. A pointer, R, is taken which falls in between the base and base+L. The process then uses a computer instruction and modifies the original pointer, R, by either adding or subtracting a constant value to derive a modified pointer, R′. Then, the starting location, S, is adjusted by setting the least significant bits (LSB) of the B bits to zero. The process then determines, the ending location, E, by taking the logical OR of S and L. If the modified pointer, R′, is derived by adding a constant, the process includes subtracting the ending location, E, from the modified pointer, R′, to derive the new offset location, O. If the offset location, O, is positive, then, the final result is derived from taking the logical OR of the determined starting location, S, and the derived offset location, O. If the modified pointer, R′, is derived by subtracting a constant, then, the process includes subtracting the modified pointer, R′, from the ending location, E, to derive the new offset location, O. If the bit corresponding to the value B+1 of the modified pointer, R′, is not equal to the bit corresponding to the value B+1 of the original pointer, R, then, the final result is the logical OR of the new starting location, S, and the new offset, O for establishing the new pointer location, R′. Otherwise, the new offset, O, determines the modified pointer location, R′.

Variations of the disclosed subject matter may include encoding the end address, E, directly instead of encoding the length of the number of bits, L. This may allow for a circular buffer of arbitrary size, while reducing the size and complexity of circular buffer calculation.

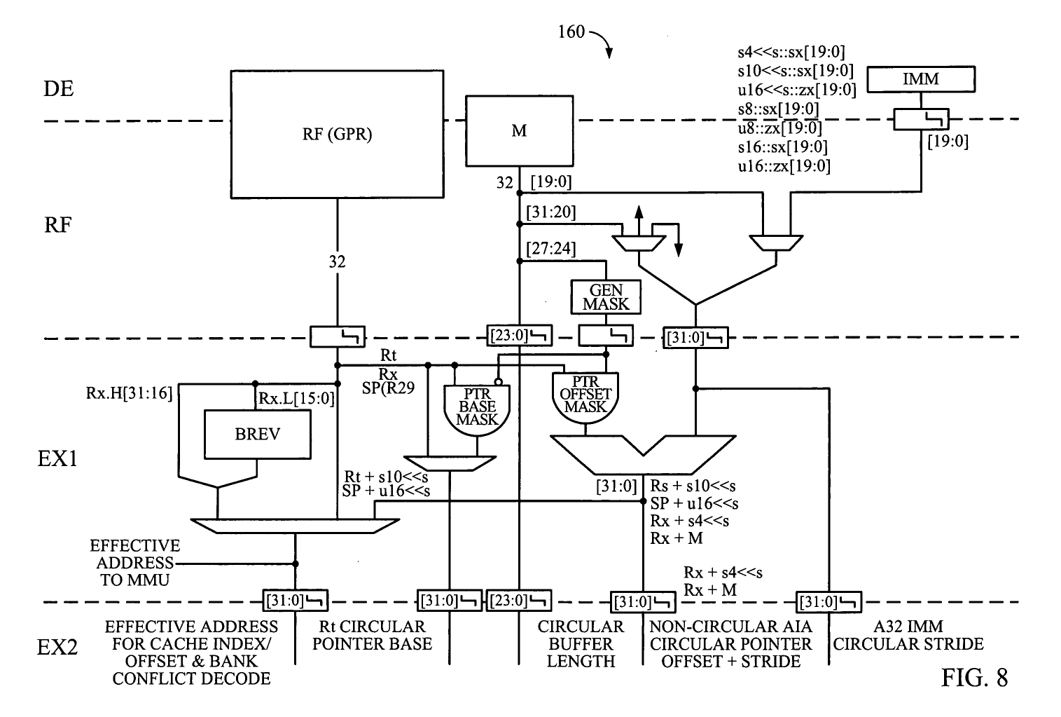

For illustrating yet another application of the present teachings, FIG. 8 provides an alternative embodiment of the disclosed subject matter for use in DSP 40 as a portion of AGU 80 which provides two identical instances of the address generating data path, one for SLOT0 and one for SLOT1. AGU 80 generates both the effective address (EA) and the auto-incremented address (the AIA) for each slot. The EA generation is based on the addressing mode and may be evaluated in (a) a register mode, (b) a register mode added with an immediate offset; and (c) a bit-reversed mode. The data path appearing in FIG. 8 shows each method with a final 3:1 EA multiplexer described as follows.

Thus, referring to FIG. 8, there appears address generation process 160. In address generation process 160, the immediate offset input into AGU 80 from CU 60 is expected to be sign/zero extended to the maximum shifted immediate offset width (19-bits). The AGU 80 sign/zero extends the offset to 32-bits.

The embodiment of FIG. 8 also provides an the auto incremented address generation process, based on the addressing mode. The auto incremented address generation process may be evaluated in (a) a register added with immediate offset mode, (b) a register added with M register offset mode, and (c) a register circular added with immediate offset mode. Address generation process 160 of FIG. 8 shows each of these methods.

Note that non-circular the auto incremented address computation is completed in AGU 80, where the circular the auto incremented address computation also requires ALU 82, in the illustrated example. Because a load or store instruction cannot both pre-increment to generate an EA and post-increment to generate the AIA, the same adder can be shared for both EA and the AIA.

In circular addressing mode, address generation process 160 maintains circular buffer 100 with accesses separated by a stride, which may be either positive or negative. The current value of the pointer is added to the stride. If the result either overflows or underflows the address range of circular buffer 100, the buffer length is subtracted or added (respectively) to have the pointer point back to a location within circular buffer 100.

In DSP 40, the start address of circular buffer 100 aligns to the smallest power of 2 greater than the length of the buffer. If the stride, which is the immediate offset, is positive, then the addition can result in two possibilities. Either the sum is within the circular buffer length in which case it is the final the AIA value, or it is bigger than the buffer length, in which case the buffer length needs to be subtracted. If the stride is negative, then the addition can again result in two outcomes.

If the sum is greater than the start address, then it is the final the AIA value. If the sum is less than the start address, the buffer length needs to be added. The data path here takes advantage of the fact that the start address is aligned to 2(K+2) and that length is required to be less than 2(K+2), where K is an instruction-specified immediate value. The Rx [31:(K+2)] value is masked to zero prior to the addition. A reverse mask preserves the prefix bits [31: (K+2)] for later use. The buffer overflow is determined, when the stride (immediate offset) is positive, by adding the masked Rx to the stride in the AGU 80 adder and subtracting the length from the sum in the ALU 82 adder. If the result is positive then the AIA [(K+2)−1:0] comes from the ALU 82 adder, otherwise the results comes from the AGU 80 adder. The AIA [31:(K+2)] equals Rx [31:(K+2)].

The buffer underflow is determined, when the stride is negative, by adding the masked Rx to the stride in the AGU adder. If this sum is positive, then the AIA [(K+2)−1:0] comes from the AGU 80 adder. If the sum is negative, then the length is added to the sum in the ALU 82 adder, and the AIA [(K+2)−1:0] comes from the ALU 82 adder. Again the AIA [31:(K+2)] equals Rx[31:(K+2)].

Note that whether length is added or subtracted in the ALU 82 adder is determined by the sign of the offset. An issue with the POR option is that it adds an AND gate to perform the mask to the Rx input of the adder, which is in the critical path. An alternative implementation is as follows.

In this case Rx is added to the stride. The sum of the AGU 80 adder (which is non-critical for the AIA) is masked, so that only sum [(K+2)−1:0] is presented as one input to the ALU 82 adder, while length or its two's complement is presented as the other input. If the stride is positive, then length is subtracted from the masked sum in the ALU adder. If the result is positive, then the AIA [(K+2)−1:0] comes from the AGU 80 adder and no overflow occurs, otherwise the result comes from the ALU adder (over flow). The AIA [31:(K+2)] always equals Rx[31:(K+2)].

If the stride is negative, if the AGU adder Sum [31:2^{(K+2)}] is compared with Rx[31:(K+2)]. If these prefix bits stayed the same, this means no underflow occurred. In this case, the AIA[(K+2)−1:0] comes from the AGU 80 adder. If the prefix bits differ, then there was an underflow. In this case length is added to the masked sum in the AGU 80 adder. The AIA[(K+2):0], in this case, comes from the AGU 80 adder. Again, the AIA [31:(K+2)] always equals Rx[31:(K+2)]. With this approach, the masking AND is eliminated from the critical path. However a 28-bit comparator is added.

The processing features and functions described herein can be implemented in various manners. For example, not only may DSP 40 perform the above-described operations, but also the present embodiments may be implemented in an application specific integrated circuit (ASIC), a micro controller, a microprocessor, or other electronic circuits designed to perform the functions described herein. The foregoing description of the preferred embodiments, therefore, is provided to enable any person skilled in the art to make or use the claimed subject matter. Various modifications to these embodiments will be readily apparent to those skilled in the art, and the generic principles defined herein may be applied to other embodiments without the use of the innovative faculty. Thus, the claimed subject matter is not intended to be limited to the embodiments shown herein but is to be accorded the widest scope consistent with the principles and novel features disclosed herein.

What is claimed is:

1. A method for addressing a circular buffer, comprising the steps of:
establishing a length of said circular buffer, said length for bounding the addressable range of said circular buffer;
establishing a start address for said circular buffer, said start address being aligned to a power of 2;
establishing an end address for said circular buffer, said end address located distant from said start address by said length and less than said power of 2 greater than said length;
determining a current pointer location for an address within said circular buffer, said current pointer location being between said start address and said end address;
determining a stride value of bits between said start address and said end address;
determining a new pointer location within said circular buffer by shifting from said current pointer location the number of bits of said stride value; and
determining an adjusted pointer location to be within said circular buffer by an arithmetic operation of said new pointer location with said length.

2. The method of claim 1, further comprising the step of setting the location of said adjusted pointer location, in the event of a positive stride by (a) in the event that said new pointer location is less than said end address, adjusting said adjusted pointer location to be the new point location; and (b) in the event that said new pointer location is greater than said end address, adjusting said adjusted pointer by subtracting said length from said new pointer location.

3. The method of claim 1, further comprising the step of setting the location of said adjusted pointer location, in the event of a negative stride by (a) in the event that said new pointer location is greater than said start address, adjusting said adjusted pointer location to be the new point location; and (b) in the event that said new pointer location is less than said start address, adjusting said adjusted pointer by adding said length to said new pointer location.

4. The method of claim 1, further comprising the step of setting said start address least significant bits to zero prior to said steps of determining said new pointer location and determining said adjusted pointer location.

5. The method of claim 1, further comprising the step of deriving said adjusted pointer location in the event of a positive stride by adding a masked address as said current pointer to said positive stride in an address generating unit and subtracting said length from a sum in an arithmetic logic unit adder.

6. The method of claim 1, further comprising the step of deriving said adjusted pointer location in the event of a negative stride by adding a masked address as said current pointer to said negative stride in an address generating unit and, in the event of a negative sum, deriving said adjusted pointer location directly from said address generating unit; otherwise, deriving said adjusted pointer location by adding said length to a sum in an arithmetic logic unit and deriving said adjusted pointer location from said arithmetic logic unit.

7. The method of claim 1, further comprising the step of using an AND gate to perform a mask of the current pointer input for generating an input into an adder of an address generating unit in generating said new pointer location.

8. The method of claim 1, further comprising the steps of:
deriving a sum of said current pointer location and said stride;
masking and presenting said sum as a first input to an adder circuit in an arithmetic logic unit and either said length or a two's complement of said length as a second input to said adder circuit.

9. A system for establishing an addressing a circular buffer, comprising:
establishing a circular buffer, said circular buffer comprising:
a length of said circular buffer, said length for bounding the addressable range of said circular buffer;
a start address for said circular buffer, said start address being aligned to a power of 2;
an end address for said circular buffer, said end address located distant from said start address by said length and less than said power of 2 greater than said length;
an address generating unit for determining a current pointer location for an address within said circular buffer, said current pointer location being between said start address and said end address;
stride determining instructions associated with said address generating unit for determining a stride value of bits between said start address and said end address;
new pointer location instructions associated with said address generating unit for determining a new pointer location within said circular buffer by shifting from said current pointer location the number of bits of said stride value; and
adjusted pointer location instructions associated with said address generating unit for determining an adjusted pointer location to be within said circular buffer by an arithmetic operation of said new pointer location with said length.

10. The system of claim 9, wherein said adjusted pointer location instructions further comprise instructions for setting the location of said adjusted pointer location, in the event of a positive stride by (a) in the event that said new pointer location is less than said end address, adjusting said adjusted pointer location to be the new point location; and (b) in the event that said new pointer location is greater than said end address, adjusting said adjusted pointer by subtracting said length from said new pointer location.

11. The system of claim 9, wherein said adjusted pointer location instructions further comprise instructions for setting the location of said adjusted pointer location, in the event of a negative stride by (a) in the event that said new pointer location is greater than said start address, adjusting said adjusted pointer location to be the new point location; and (b) in the event that said new pointer location is less than said start address, adjusting said adjusted pointer by adding said length to said new pointer location.

12. The system of claim 9, wherein said new pointer location instructions further comprise instructions for setting said start address least significant bits to zero prior to determining said new pointer location and determining said adjusted pointer location.

13. The system of claim 9, wherein said adjusted pointer location instructions further comprise instructions for deriving said adjusted pointer location, in the event of a positive stride, by adding a masked address as said current pointer to said positive stride in said address generating unit and subtracting said length from a sum in an arithmetic logic unit adder.

14. The system of claim 9, wherein said adjusted pointer location instructions further comprise instructions for deriving said adjusted pointer location, in the event of a negative stride, by adding a masked address as said current pointer to said negative stride in said address generating unit and, in the event of a negative sum, deriving said adjusted pointer location directly from said address generating unit; otherwise, deriving said adjusted pointer location by adding said length to a sum in an arithmetic logic unit and deriving said adjusted pointer location from said arithmetic logic unit.

15. The system of claim 9, further comprising:
an arithmetic logic unit for cooperating with said address generating unit in determining said current pointer location, said stride value, and said adjusted pointer location, and
wherein said address generating unit comprises an AND gate and an adder circuit; and
further wherein said adjusted pointer location instructions comprise instructions for using an AND gate to perform a mask of the current pointer input for generating an input into an adder of an address generating unit in generating said new pointer location.

16. The system of claim 9, further comprising:
an arithmetic logic unit for cooperating with said address generating unit in determining said current pointer location, said stride value, and said adjusted pointer location;
summing instructions associated with said adjusted pointer location instructions for deriving a sum of said current pointer location and said stride; and
masking instructions for masking and presenting said sum as a first input to an adder circuit in an arithmetic logic unit and either said length or a two's complement of said length as a second input to said adder circuit.

17. A digital signal processor for processing digital signals and comprising a circular buffer controlling and addressing means, comprising:
means for establishing a length of said circular buffer, said length for bounding the addressable range of said circular buffer;
means for establishing a start address for said circular buffer, said start address being aligned to a power of 2;
means for establishing an end address for said circular buffer, said end address located distant from said start address by said length and less than a power of 2 greater than said length;
means for determining a current pointer location for an address within said circular buffer, said current pointer location being between said start address and said end address;
means for determining a stride value of bits between said start address and said end address;
means for determining a new pointer location within said circular buffer by shifting from said current pointer location the number of bits of said stride value; and
means for determining an adjusted pointer location to be within said circular buffer by an arithmetic operation of said new pointer location with said length.

18. The digital signal processor of claim 17, further comprising means for setting the location of said adjusted pointer location, in the event of a positive stride by (a) in the event that said new pointer location is less than said end address, adjusting said adjusted pointer location to be the new point location; and (b) in the event that said new pointer location is greater than said end address, adjusting said adjusted pointer by subtracting said length from said new pointer location.

19. The digital signal processor of claim 17, further comprising means for setting the location of said adjusted pointer location, in the event of a negative stride by (a) in the event that said new pointer location is greater than said start address, adjusting said adjusted pointer location to be the new point location; and (b) in the event that said new pointer location is less than said start address, adjusting said adjusted pointer by adding said length to said new pointer location.

20. The digital signal processor of claim 17, further comprising means for setting said start address least significant bits to zero prior to said steps of determining said new pointer location and determining said adjusted pointer location.

21. The digital signal processor of claim 17, further comprising means for deriving said adjusted pointer location in the event of a positive stride by adding a masked address as said current pointer to said positive stride in an address generating unit and subtracting said length from a sum in an arithmetic logic unit adder.

22. The digital signal processor of claim 17, further comprising means for deriving said adjusted pointer location in the event of a negative stride by adding a masked address as said current pointer to said negative stride in an address generating unit and, in the event of a negative sum, deriving said adjusted pointer location directly from said address generating unit; otherwise, deriving said adjusted pointer location by adding said length to a sum in an arithmetic logic unit and deriving said adjusted pointer location from said arithmetic logic unit.

23. The digital signal processor of claim 17, further comprising means for using an AND gate to perform a mask of the current pointer input for generating an input into an adder of an address generating unit in generating said new pointer location.

24. The digital signal processor of claim 17, further comprising:
means for deriving a sum of said current pointer location and said stride; and
means for masking and presenting said sum as a first input to an adder circuit in an arithmetic logic unit and either said length or a two's complement of said length as a second input to said adder circuit.

25. A computer usable medium having computer readable program code means embodied therein for processing instructions on digital signal processor, the computer usable medium comprising:
computer readable program code means for establishing a length of said circular buffer, said length for bounding the addressable range of said circular buffer;
computer readable program code means for establishing a start address for said circular buffer, said start address being aligned to a power of 2;
computer readable program code means for establishing an end address for said circular buffer, said end address located distant from said start address by said length and less than said power of 2 greater than said length;
computer readable program code means for determining a current pointer location for an address within said circular buffer, said current pointer location being between said start address and said end address;
computer readable program code means for determining a stride value of bits between said start address and said end address;
computer readable program code means for determining a new pointer location within said circular buffer by shifting from said current pointer location the number of bits of said stride value; and
computer readable program code means for determining an adjusted pointer location to be within said circular buffer by an arithmetic operation of said new pointer location with said length.

26. The computer usable medium of claim 25, further comprising computer readable program code means for setting the location of said adjusted pointer location, in the event of a positive stride by (a) in the event that said new pointer location is less than said end address, adjusting said adjusted pointer location to be the new point location; and (b) in the event that said new pointer location is greater than said end address, adjusting said adjusted pointer by subtracting said length from said new pointer location.

27. The computer usable medium of claim 25, further comprising computer readable program code means for setting the location of said adjusted pointer location, in the event of a negative stride by (a) in the event that said new pointer location is greater than said start address, adjusting said adjusted pointer location to be the new point location; and (b) in the event that said new pointer location is less than said start address, adjusting said adjusted pointer by adding said length to said new pointer location.
